(19) United States
(12) Patent Application Publication
(10) Pub. No.: US 2024/0376879 A1
(43) Pub. Date: Nov. 14, 2024

(54) DEVICE FOR DECOMPRESSION OF A GAS CONTAINER

(71) Applicant: GRTGAZ, Bois Colombes (FR)

(72) Inventors: Marc VANBALEGHEM, Bois Colombes (FR); Alban SESMAT, Bois Colombes (FR); Marc DA COSTA, Bois Colombes (FR); Maud TESTARD, Bois Colombes (FR)

(21) Appl. No.: 18/291,938

(22) PCT Filed: Jul. 25, 2022
(86) PCT No.: PCT/EP2022/070755

§ 371 Date: Jan. 25, 2024

(30) Foreign Application Priority Data
Jul. 26, 2021 (FR) FR2108062

(51) Int. Cl. F04B 39/12; F04B 39/00; F04B 41/02

(52) U.S. Cl. CPC F04B 39/123; F04B 39/0005; F04B 41/02

(57) ABSTRACT

The device (40) performs the decompression of a first gas container (12) by extracting gas present in this first container, compressing the extracted gas and injecting the compressed gas into a second gas container (13).

The device comprises:
a source of compressed air (14);
a pneumatic booster (30) equipped with an expansion chamber (17) and a compression chamber (23);
a first pipe (31), for air, between the compressed air outlet of the source of compressed air and an inlet (18) of the expansion chamber;
a second pipe (32), for air, connected to an outlet (19) of the expansion chamber;
a third pipe (33), for gas, between the first container and an inlet (15) of the compression chamber; and
a fourth pipe (34), for compressed gas, between an outlet (16) of the compression chamber and the second gas container.

### TECHNICAL FIELD OF THE INVENTION

The present invention relates to a device for decompressing a gas container, for example a section of a gas network or a gas reservoir. It applies, in particular, to the following fields: transport and distribution networks for natural gas, biogas and hydrogen, or other gases, butane, propane, etc.; cylinder filling stations; the field of maintenance for NGV (acronym for natural gas for vehicles) heavy goods vehicles; internal plant networks.

### STATE OF THE ART

It is sometimes necessary to decompress a reservoir or a section of a gas network on which interventions are planned, for example modification, maintenance or repair work. Currently, during scheduled maintenance operations on gas transport and distribution networks, in garages for NGV heavy goods vehicles, in internal plant networks, in units filling butane, propane, hydrogen, etc. reservoirs, the quantities of gas, in particular methane CH₄, present in portions of the pipes must be removed, in some cases discharged into the atmosphere, in order to carry out the controls and implement the operating mode associated with the operation.

The quantities of gas vented into the atmosphere depend on the type of installation and the pressure downstream.

To reduce the loss of gas contained in this section or this reservoir, and limit the environmental impact, a mobile compression station can be used to extract the gas from the section or reservoir to be drained and then reinject it into an operational gas network.

There are no commercially available products that are simple to use and make possible a transfer of methane, or another gas, and a possible storage or easy recovery that would limit discharges into the atmosphere.

There are compressors that are moveable and transportable, powered either by the power grid (220 volts in Europe) or by the battery of an intervention vehicle associated to an inverter supplying an alternating current of 220 volts. But these compressors are not sized for compressing the gas from the section or reservoir to be drained and transferred at the pressure of the functional gas network intended to receive it.

There are standard piston compressors driven by electric motors, or combustion motors. But these compressors are generally over-sized for the required use, and have a three-phase power supply linked to the ATEX (“explosive atmosphere”) motors they are equipped with. Because of this, there are no suitable solutions for stations with a low or single-phase power supply, especially sites without electricity.

An ATEX zone is a place in which there is a significant explosive risk, i.e. flammable materials are present. The risk is determined by the nature and quantity of flammable substances present. As the quantity and dangerous nature increase, the more the ATEX zone is considered to have a high explosive risk. It is therefore subject to more stringent regulations.

### DESCRIPTION OF THE INVENTION

The present invention aims to remedy all or part of these drawbacks. In particular, the present invention is intended to determine the extent of the ATEX zone and avoid placing certain resources in this zone, so they do not have to comply with the ATEX standards.

To this end, the present invention envisions a device for decompressing a first container of explosive gas, for example a section of a gas network or a gas reservoir, by extracting gas present in this container, compressing the extracted gas and injecting the compressed gas into a second gas container, for example a gas network or a gas reservoir, which device comprises:
a source of compressed air, for example an air compressor, positioned outside a perimeter of an explosive atmosphere zone around the first container, the perimeter being determined based on the explosive gas in the first container;
a pneumatic booster equipped with an expansion chamber and a compression chamber, positioned inside the perimeter of the explosive atmosphere zone;
a first pipe, for air, between the compressed air outlet of the source of compressed air and an inlet of the expansion chamber;
a second pipe, for air, connected to an outlet of the expansion chamber;
a third pipe, for gas, between the first container and an inlet of the compression chamber; and
a fourth pipe, for compressed gas, between an outlet of the compression chamber and the second gas container.

In some embodiments, the device also comprises a means for determining a perimeter of an explosive atmosphere zone around a first container based on the explosive gas in the first container.

Thanks to these provisions, the energy released by the expansion of the compressed air in the pneumatic booster enables the gas coming from the first gas container to be compressed in the pneumatic booster. Thus a transfer and recovery of gas, for example methane, is performed and discharges of gas into the atmosphere are reduced. More generally, a decarbonisation of gas uses is realised.

In addition, the compressed air source can be simplified compared to a compressed air source positioned inside the explosive atmosphere zone. The cost of the device can therefore be reduced. In some embodiments, the means for determining a perimeter of an explosive atmosphere zone comprises a means for collecting an item of information representative of the perimeter of the explosive atmosphere zone based on the explosive gas in the first container.

Thanks to these provisions, it is possible to interrogate a database containing information representative of the explosive atmosphere zone. For example, this database can be maintained by the operator of the installation.

In some embodiments, the means for determining a perimeter of an explosive atmosphere zone comprises a means for calculating the perimeter based on the explosive gas in the first container.

Thanks to these provisions, the perimeter can be calculated on-site using a marking representative of the explosive atmosphere zone of the first container. These embodiments mean that access to a telecommunications network is not required.

In some embodiments, the means for determining a perimeter of an explosive atmosphere zone comprises a means for capturing the perimeter.

Thanks to these provisions, the perimeter known from elsewhere can be entered manually by a user.

In some embodiments, the device that is the subject of the present invention comprises a means for measuring the distance between the compressed air source and the pneumatic booster, and a means for comparing the distance measured with the perimeter representative of the explosive atmosphere zone determined.

Thanks to these provisions, a user can verify that the compressed air source is well positioned and that the explosive atmosphere zone is respected.

In some embodiments, the device that is the subject of the present invention comprises a means for issuing an alert when the distance measured is inside the perimeter of the explosive atmosphere zone determined.

Thanks to these provisions, when the explosive atmosphere zone is not respected, a user can be alerted directly in order to avoid any risk.

In some embodiments, the pneumatic booster comprises a free piston between the expansion chamber and the compression chamber.

The expansion of the compressed air makes it possible to move the free piston of the booster, which compresses the gas collected from the first gas container to be drained, to a sufficiently high pressure for injecting into the second gas container, for example an operational network.

In this way, the invention makes it possible, with a simple air compressor or a reservoir of pressurised air, to drain a network of gas to be drained and to transfer the gas into an operational gas network or into a reservoir.

In some embodiments:
the free piston comprises an expansion head and a compression head connected by a shaft, a through-opening that opens on one side into the expansion head on the opposite side from the compression head and, on the other side, into a side wall of the shaft;
the first air pipe opens into the expansion chamber opposite the shaft; and
the outlet of the expansion chamber to which the second air pipe is connected is located on a side surface of the expansion chamber, and is only closed by the expansion head when the through-opening does not open into the expansion chamber.

In some embodiments, the compressed air source is an air compressor, and the inlet for air to be compressed of the air compressor is connected to the second air pipe.

The air is therefore kept in a closed circuit, eliminating or reducing the need for this air to be filtered.

In some embodiments, the pneumatic booster comprises a turbo-compressor between the expansion chamber and the compression chamber.

In some embodiments, the device that is the subject of the invention comprises a downstream pressure regulator on the second air pipe between the expansion chamber of the booster and the compressor.

Therefore, the compressor is supplied with air at a constant pressure.

In some embodiments, the compressed air source comprises a reservoir of compressed air.

In some embodiments, the device that is the subject of the invention comprises an upstream pressure regulator positioned on the fourth gas pipe.

Thanks to these provisions, the pressure on output from the compression chamber of the booster and the temperature in a heat exchanger positioned on the fourth gas pipe are constant.

In some embodiments:
the first gas container is a section of a gas network;
the first gas container is a gas reservoir;
the second gas container is an operational gas network; and/or
the second gas container is a gas reservoir mounted on a vehicle.

### BRIEF DESCRIPTION OF THE FIGURES

Other advantages, aims and particular features of the invention will become apparent from the non-limiting description that follows of at least one particular embodiment of the compression device that is the subject of the present invention, with reference to drawings included in an appendix, wherein:

FIG. 1 represents, schematically, a first particular embodiment of the device that is the subject of the invention;

FIG. 2 represents, schematically, a second particular embodiment of the device that is the subject of the invention;

FIG. 3 represents, schematically, a first particular embodiment of a free piston utilised in different embodiments of the device that is the subject of the invention;

FIG. 4 represents, schematically, a first operating phase of a free piston with a through-opening;

FIG. 5 represents, schematically, a second operating phase of a free piston with a through-opening;

FIG. 6 represents, schematically, a third operating phase of a free piston with a through-opening; and

FIG. 7 represents, schematically, a fourth operating phase of a free piston with a through-opening.

### DESCRIPTION OF THE EMBODIMENTS

The present description is given in a non-limiting way, in which each characteristic of an embodiment can be combined with any other characteristic of any other embodiment in an advantageous way.

Note that the figures are not to scale.

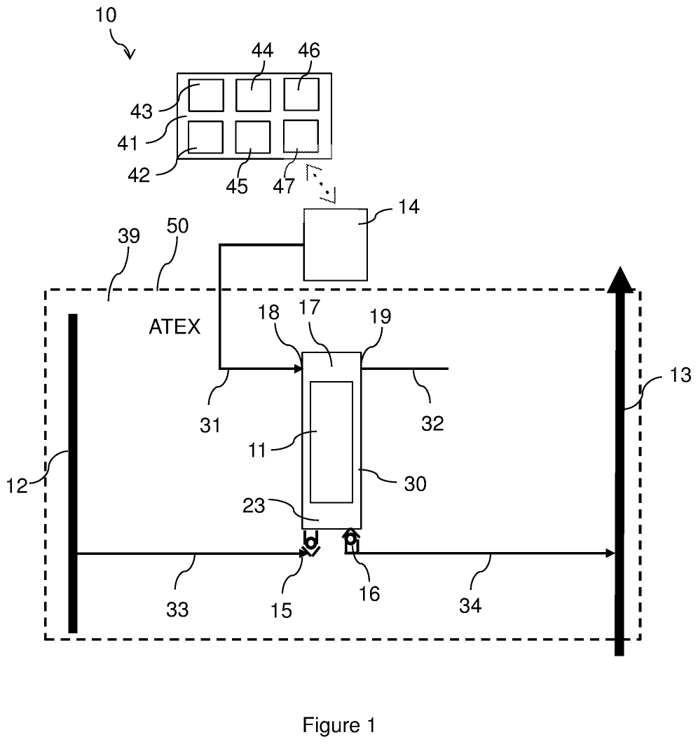

Preferably, so as to use the expansion energy of one fluid to compress a second fluid, the device that is the subject of the invention utilises a pneumatic booster or a free piston. It is the version with a free piston that is represented in FIGS. 1 to 7. Note that, in a free-piston booster, the movement of the piston responds only to the pressure of the gas, without a connecting rod actuating it or holding it. The person skilled in the art can easily replace this free piston by a membrane pneumatic booster or by a turbo-compressor, for example.

In the first embodiment shown in FIG. 1, the device 10 for decompressing a first gas container 12, for example a section of a gas network or a gas reservoir at a low pressure, typically close to atmospheric pressure, operates by extracting gas present in this first container 12, compressing the extracted gas and injecting the compressed gas into a second gas container 13, for example an operational gas network (typically between 4 and 30 bar), as shown, or a gas reservoir (not shown) possibly carried by a vehicle.

The device 10 comprises a compressed air source 14, and a pneumatic booster 30 equipped with an expansion chamber 17 and a compression chamber 23. A first pipe 31, for air, connects the compressed air outlet of the compressed air source 14 to an inlet 18 of the expansion chamber 17.

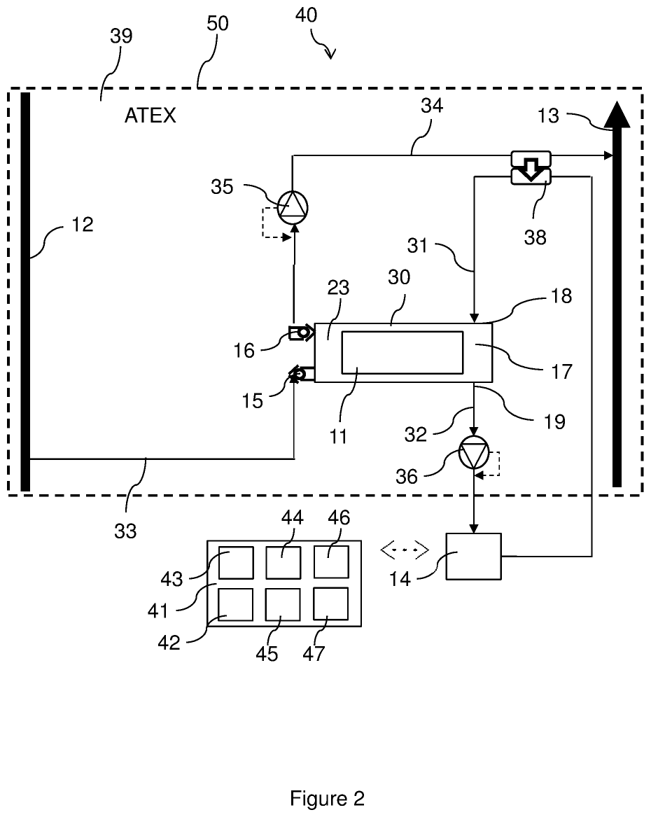

In the case of a compressed air source 14 comprising an air compressor, as shown in FIG. 2, preferably, a second pipe 32, for air, connects an outlet 19 of the expansion chamber 17 to an inlet for air to be compressed of the air compressor 14. In a variant shown in FIG. 1, the second air pipe 32 vents the expanded air on output from the expansion chamber 17 into the atmosphere.

In variants, the compressed air source 14 comprises a reservoir of compressed air under pressure, for example carried by the same vehicle that carries a reservoir intended to receive the gas collected by means of the fourth pipe 34. Therefore, a truck, a carriage or a trailer can be equipped with compressed air cylinders, for example at 300 bar, which serve as driving energy for the booster 30 in the place of an air compressor 14 shown in FIGS. 1 and 2. In the example mentioned (300 bar), an expander, for example supplying on output a gas at 10 bar of pressure, corresponds to the specifications of the air compressor 14. One advantage of these variants is that it is not necessary to have another driving energy, for example a source of thermal or electrical energy, to utilise the device 10 or 40.

A third pipe 33, for gas, connects the first container 12 to an inlet 15 of the compression chamber 23. A fourth pipe 34, for compressed gas, connects an outlet 16 of the compression chamber 23 to the second gas container 13.

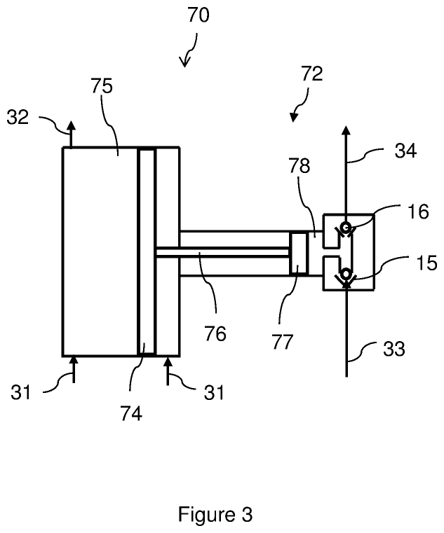

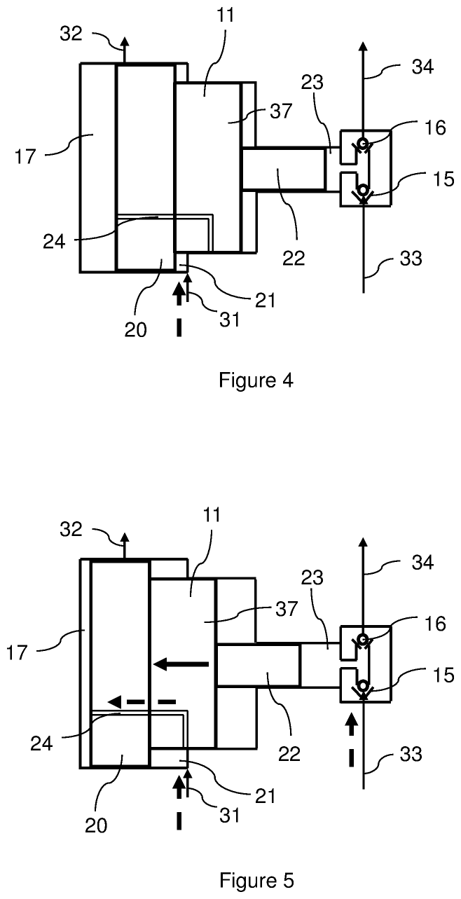

In this way, the energy released by expanding air in the pneumatic booster 30 enables gas to be compressed in the pneumatic booster 30. Preferably, the pneumatic booster 30 comprises a free piston 11 moving between the expansion chamber 17 and the compression chamber 23. Two embodiments of the free-piston booster are described with reference to FIG. 3, on the one hand, and FIGS. 4 to 7, on the other hand.

The expansion of the compressed air supplied by the compressed air source 14, performed by the device 10, makes it possible to move the free piston 11 of the booster 30, which free piston 11 compresses the gas collected from the first container 12 to be drained, to a sufficiently high pressure for injecting into the second gas container 13.

Therefore, the device 10 makes it possible to implement a compression station between the first gas container to be drained 12, for example a section of a network, and the second gas container 13, for example an operational gas network.

In some embodiments, such as that shown in FIG. 2, elements are added to automate or improve the operation of the device 40 that is the subject of the invention.

The decompression device 40 comprises an upstream pressure regulator 35 positioned on the fourth gas pipe 34. Note that an upstream pressure regulator (also referred to as a “controller”) regulates the pressure on its upstream side. The pressure on output from the compression chamber 23 of the booster 30 on the fourth gas pipe 34 is therefore constant.

The decompression device 40 comprises a downstream pressure regulator 36 on the second air pipe 32 between the expansion chamber 17 of the booster 30 and the compressor 14. Therefore, the compressor 14 is supplied with gas at a constant pressure. Note that the downstream pressure regulator regulates the pressure on its downstream side.

A heat exchanger 38 enables the air to be expanded in the first air pipe 31 to be heated by the compressed gas present in the gas pipe 34, and thus avoid the problems of cold for the booster 30, second air pipe 32, downstream pressure regulator 36 and/or compressor 14.

It can be seen that the invention enables the compressor 14 with an electric or combustion motor to be positioned outside an explosive atmosphere (“ATEX”) zone 39 where its use would impose significant technical constraints.

Preferably, the embodiments 10 and 40 of the device that is the subject of the present invention each comprise a means 41 for determining a perimeter 50 of an explosive atmosphere zone 39 around the first container based on the explosive gas in the first container 12. The determination means 41 can be incorporated into the compressed air source 14 or into a mobile terminal (not shown). The mobile terminal can be any type known to the person skilled in the art, such as a digital tablet, a smartphone, a connected watch, or a portable computer.

Preferably, the determination means 41 comprises at least one screen on which a graphical user interface is displayed, and a capture means such as a virtual or physical keyboard. The determination means 41 is, for example, a microprocessor.

The determination means 41 can comprise a means 42 for collecting an item of information representative of the perimeter of the explosive atmosphere zone based on the explosive gas in the first container 12. For example, the collection means 42 can comprise a means for communicating with a remote server hosting a database containing at least one perimeter of an explosive atmosphere zone associated to at least one explosive gas. The database can also associate a perimeter to additional data such as a level of classification.

A user can enter the gas of the first container and the collection means 42 interrogates the database to retrieve the corresponding perimeter 50. Preferably, when the gas of the first container 12 is not in the database, or when no perimeter is associated to the gas of the first container 12 in the database, a default value is retrieved by the collection means 42. For example, the default perimeter can be the largest possible perimeter value.

The perimeter 50 collected by the collection means can be displayed on a screen or used in subsequent processing.

In some embodiments, the means 41 for determining a perimeter 50 of an explosive atmosphere zone comprises a means 43 for calculating the perimeter 50 based on the explosive gas in the first container 12. The explosive gas of the first container 12 can be captured in the determination means 41 and the calculation means 43 automatically calculates the perimeter 50 based on the gas entered. The calculation means 43 is configured to apply the rules for calculating explosive atmosphere zones.

In some embodiments, the calculation means 43 comprises a communication means, which can be combined with the communication means of the collection means 42. The rules for calculating explosive atmosphere zones can be updated according to information transmitted by the communication means.

In some embodiments, the means 41 for determining a perimeter of an explosive atmosphere zone comprises a means 44 for capturing the perimeter. The capture means 44 can be the same as the means above. If the perimeter is identified on the first container 12, the user can enter this information directly.

The capture means comprises an Optical Character Recognition (acronym OCR) means. In this way, the gas of the first container or the perimeter can be recognised directly by the capture means.

The device 10 or 40 can be equipped with a means for automatically detecting the gas of the first container 12. The gas recognised can then be supplied to the calculation means 43 or collection means 42.

Preferably, the device 10 and 40 comprises a means 45 for measuring the distance between the compressed air source and the pneumatic booster, and a means 46 for comparing the distance measured with the perimeter representative of the explosive atmosphere zone determined. The measurement means 45 is, for example, a laser sensor positioned at the location of the compressed air source 14. The laser sensor is pointed towards the explosive atmosphere zone, possibly represented by a marker, and the distance between the marker and the compressed air source 14 is measured automatically. The value measured can then be transmitted to the comparison means 46.

In a variant, the measurement means 45 is a tape measure rolled out between a marker and the compressed air source. The distance measured is read by a user then entered by the user to be used by the comparison means 46.

The comparison means 46, for example a microprocessor, can be incorporated into a mobile terminal or into the determination means 41. Preferably, the comparison means 46 verifies that the distance measured corresponds to a positioning of the compressed air source 14 inside the perimeter determined or outside the perimeter determined. When the compressed air source 14 is inside the perimeter determined, an alert can be issued by an emission means 47. The alert can be visual, e.g. a display on a screen or the blinking of a light, or audible, e.g. issued by means of an electroacoustic transducer.

Note that the screens, capture means and microprocessors described above can correspond to the same element respectively, for example incorporated into a mobile terminal.

FIG. 3 shows a booster, i.e. a pair of an expander 70, on the left, and a compressor 72, on the right, with a free piston. The expander 70 comprises an expansion chamber 75 equipped with an inlet for high-pressure air coming from the first air pipe 31 and an outlet for low-pressure air into the second air pipe 32. In the chamber 75, an expansion piston 74 is put into motion by the pressure of the air and transmits this pressure, by means of a shaft 76, to a compression piston 77 which compresses the gas in a compression chamber 78. The assembly of the pistons 74 and 77 and the shaft 76 forms a free piston.

Valves 15 and 16 ensure the tightness and the direction of movement of the gas from the third gas pipe 33 inputting low-pressure gas through to the fourth pipe 34 outputting high-pressure gas. The system for controlling the input of gas into the expansion chamber 75 and the output of air from the chamber 75, is not described here, being well known to the person skilled in the art.

Therefore, a free piston is set in motion in a first chamber 75 by the compressed air and compresses the gas in a second chamber 78. The compressor 72 is driven by the expander 70 with very low mechanical losses, which increases the efficiency of the booster. Note that the pressure of the gas at the outlet from the booster 70 can be higher than the pressure of the air at the inlet of the expansion chamber 75, depending on the ratio of the surface areas of the pistons 74 and 77.

In a variant, the free piston can be replaced by membranes, such as known types of membrane boosters, or by a rotating turbine-compressor assembly, such as known types of turbo-compressors. The turbo-compressor is a rotating booster, the axis of movement being a rotary axis.

FIGS. 4 to 7 show a free-piston booster 11. The dashed arrows represent the movements of air, on the left, and gas, on the right. The solid arrow represents the movements of the free piston. In the description below, the compressed air source 14 is considered to comprise an air compressor.

The free piston 11 comprises an expansion head 20 and a compression head 22 connected by a shaft 37. A through-opening 24 opens on one side into the expansion head 20 on the opposite side from the compression head 22 and, on the other side, into a side wall of the shaft 37. The first air pipe 31 opens into the portion 21 of the expansion chamber 17 opposite the shaft 37. Consequently, the mouth of the through-opening 24 is only located in the portion 21 when the free volume of the compression chamber 23 is maximum. The outlet of the expansion chamber 17 to which the second air pipe 32 is connected is located on a side surface of the expansion chamber 17, and is only closed by the expansion head 20 when the through-opening 24 does not open into the portion 21 of the expansion chamber 17. More specifically, the outlet of the expansion chamber 17 is closed by the expansion head 20 except in the position of the free piston 11 where the free volume of the compression chamber 23 is minimum.

At the start of the operating cycle of the booster, as shown in FIG. 4, the free volume of the compression chamber 23 is intermediate between its extreme values. The pressure in the portion 17 of the expansion chamber opposite the compression chamber 23 is at the value Pb at the inlet of the compressor 14. The air coming from the first air pipe 31 enters the intermediate portion 21 of the expansion chamber at a pressure of Pa. The ratio of the pressures Pa/Pb is higher than the ratio of the surface areas of the expansion head 20 in the portion 17 and in the portion 21. The free piston 11 therefore moves to the left, as shown in FIG. 5. This movement of the free piston 11 results in the suction of gas coming from the third gas pipe 33 through the inlet valve 15.

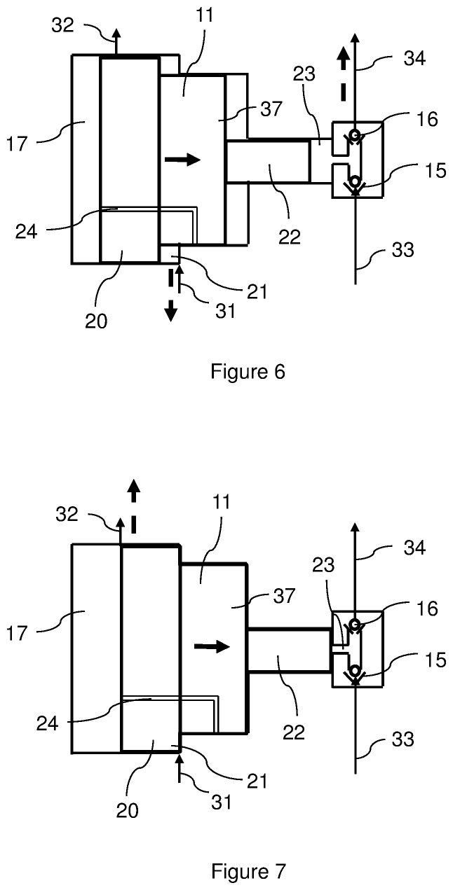

When the free volume of the compression chamber 23 is maximum, the through-opening 24 opens onto the portion 21 of the expansion chamber, and the air coming from the first air pipe 31 traverses the expansion head. The pressure in the portion 17 of the expansion chamber therefore reaches Pa, which causes the free piston 11 to move towards the compression chamber 23, as shown in FIG. 6. This movement closes the through-opening 24 and compresses the gas present in the compression chamber 23. The compressed gas traverses the outlet valve 16 and then the fourth gas pipe 34. When the free volume of the compression chamber 23 is minimum, the portion 17 of the expansion chamber is pneumatically connected to the second air pipe 32 as shown in FIG. 7. Because of the increase in the volume of the portion 17, the pressure in the portion 17 of the expansion chamber drops to reach the value Pb. The cycle then begins again.

As can be understood by reading the description above, this free-piston booster 11 operates with no external movable element and provided there is a sufficient difference in pressure between the first air pipe 31 and the second air pipe 32.

The invention makes it possible to produce a mobile system that is hooked up easily with quick couplings, a system that uses the technology of the booster with a driving energy of compressed air type, for example at 10 bar, supplied for a compressed air source 14, preferably movable and transportable, for example a compressor powered either by the mains (220 volts in Europe) or by the battery of an intervention vehicle associated to an inverter supplying an alternating current of 220 volts.

One example of use of the invention concerns stations with a maximum downstream pressure of 5 bar, the methane being recovered up to a pressure of 200 mbar. The compressed air which serves as driving energy is then released into the atmosphere. The system is designed and sized such that the transfer operations are rapid for the quantities targeted, for example a maximum of 30 minutes to recover several Nm³/h. Of course, the invention also applies to pressures above 5 bar, possibly through an expansion of the gas, depending on the type of booster used.

The invention applies to any transfer of gas and/or fluid, all operations of industrial sites linked with activities using gaseous or liquid fluids, or pressurised reservoirs. The invention also applies to the draining of light vehicles, heavy vehicles, trucks, buses, garbage trucks, methane carriers, loading arms for Butane, Propane and other gases. The invention applies to any operation of slow depressurisation or decompression and re-transfer to a transport or storage unit.

The applications of the invention cover the whole of the oil and gas industry (carriers, distributors, customers and internal networks).

1. Device for decompressing a first container of explosive gas, for example a section of a gas network or a gas reservoir, by extracting gas present in this first container, compressing the extracted gas and injecting the compressed gas into a second gas container, for example a gas network or a gas reservoir, characterised in that it comprises:
a source of compressed air, for example an air compressor, positioned outside a perimeter of an explosive atmosphere zone around the first container, the perimeter being determined based on the explosive gas in the first container;
a pneumatic booster equipped with an expansion chamber and a compression chamber, positioned inside the perimeter of the explosive atmosphere zone;
a first pipe, for air, between the compressed air outlet of the source of compressed air and an inlet of the expansion chamber;
a second pipe, for air, connected to an outlet of the expansion chamber;
a third pipe, for gas, between the first container and an inlet of the compression chamber; and
a fourth pipe, for compressed gas, between an outlet of the compression chamber and the second gas container.

2. Device according to claim 1, which also comprises a means for determining a perimeter of an explosive atmosphere zone around the first container based on the explosive gas in the first container.

3. Device according to claim 2, wherein the means for determining a perimeter of an explosive atmosphere zone comprises a means for collecting an item of information representative of the perimeter of the explosive atmosphere zone based on the explosive gas in the first container.

4. Device according to ono of claim 2, wherein the means for determining a perimeter of an explosive atmosphere zone comprises a means for calculating the perimeter based on the explosive gas in the first container.

5. Device according to claim 2, wherein the means for determining a perimeter of an explosive atmosphere zone comprises a means for capturing the perimeter.

6. Device according to claim 2, which comprises a means for measuring the distance between the compressed air source and the pneumatic booster, and a means for comparing the distance measured with the perimeter representative of the explosive atmosphere zone determined.

7. Device according to claim 6, which comprises a means for issuing an alert when the distance measured is inside the perimeter of the explosive atmosphere zone determined.

8. Device claim 1, wherein the pneumatic booster comprises a free piston between the expansion chamber and the compression chamber.

9. Device according to claim 8, wherein:
the free piston comprises an expansion head and a compression head connected by a shaft, a through-opening that opens on one side into the expansion head on the opposite side from the compression head and, on the other side, into a side wall of the shaft;
the first air pipe opens into the expansion chamber opposite the shaft; and
the outlet of the expansion chamber to which the second air pipe is connected is located on a side surface of the expansion chamber, and is only closed by the expansion head when the through-opening does not open into the expansion chamber.

10. Device according to claim 1, wherein the pneumatic booster comprises a turbo-compressor between the expansion chamber and the compression chamber.

11. Device according to claim 1, wherein the compressed air source comprises an air compressor, and the inlet for air to be compressed of the air compressor is connected to the second air pipe.

12. Device according to claim 11, which comprises a downstream pressure regulator on the second air pipe between the expansion chamber of the booster and the air compressor.

13. Device according to claim 1, wherein the compressed air source comprises a reservoir of compressed air.

14. Device according to claim 1, which comprises an upstream pressure regulator positioned on the fourth gas pipe.

15. Device according to claim 1, wherein the first gas container is a section of a gas network.

16. Device according to claim 1, wherein the first gas container is a gas reservoir.

17. Device according to claim 1, wherein the second gas container is an operational gas network.

18. Device according to claim 1, wherein the second gas container is a gas reservoir mounted on a vehicle.
